(19) United States
(12) Patent Application Publication
(10) Pub. No.: US 2003/0193854 A1
(43) Pub. Date: Oct. 16, 2003

(54) Triaxial driving apparatus of optical pickup actuator

(75) Inventors: Ho-Cheol Lee, Seoul (KR); Yong-Han Yoon, Suwon-si (KR); Ho-Seop Jeong, Sungnam-si (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 10/179,887

(22) Filed: Jun. 26, 2002

(30) Foreign Application Priority Data
Apr. 11, 2002 (KR) 2002.-19610

(51) Int. Cl. G11B 7/095

(52) U.S. Cl. 369/44.16; 369/244

(57) ABSTRACT

An optical pickup actuator performing the triaxial driving operation includes an objective lens through which a laser beam is focused on an optical disk, a blade mounted with tracking coils and focusing coils and a plurality of tilting magnets, a yoke plate having inside and outside yokes mounted with tracking and focusing magnets and also having a tilting yoke being spaced-apart from the inside and outside yokes, a plurality of suspension wires disposed on both sides of the blade to be electrically coupled to the tracking coils and focusing coils, a wire holder having a plurality of coupling elements through which each portion of the suspension wires passes, a yoke receptacle disposed between the coupling elements of the yoke plate to receive the tilting yoke, and a printed circuit board mounted on the holder to be electrically coupled to the suspension wires, and a tilting coil mounted on the wire holder and disposed in the yoke receptacle to generate an electromagnetic force.

### CROSS-REFERENCE TO RELATED APPLICATION

This application claims the benefit of Korean Application No. 2002-19610, filed Apr. 11, 2002, in the Korean Industrial Property Office, the disclosure of which is incorporated herein by reference.

### BACKGROUND OF THE INVENTION

1. Filed of the Invention

The present invention relates to a triaxial driving apparatus in an optical pickup actuator performing a triaxial driving operation, and more particularly, to an optical pickup actuator having an objective lens, through which a laser beam is impinged on and reflected from a disk, and a triaxial driving apparatus simultaneously performing focusing, tacking, and tilting operations without interfering with each other to precisely move the objective lens with respect to the disk.

2. Description of the Related Art

Generally, an optical pickup actuator is used for reading data from and writing the data on an optical disk and controlling a laser beam transmitted through an objective lens to be precisely focused on a track and a surface of the optical disk. A more precise technique of driving the optical pickup actuator is required as a storage capacity of the optical disk increases. A numerical aperture of the objective lens increases in proportion to the increase of the storage capacity of the optical disk, and the increase of the numerical aperture of the objective lens causes the aberration when the optical disk is tilted with respect to the objective lens. A reproducing capability of the optical pickup actuator decreases due to the increase of the numerical aperture, and the increase of the numerical aperture causes writing signals of the optical disk to deteriorate due to the deformation of a pit formed on the optical disk in an information writing operation.

In order to overcome the above problems, a tilting apparatus is required to compensate for a tilt error as well as focusing and tracking errors, and various tilting methods have been used in the optical pickup actuator. One of the tilting methods is to move the entire optical pickup actuator by using a DC motor, and another tilting method is to control a driving portion of the optical pickup actuator to compensate for the tilt error generated when the optical disk is tilted with respect to the optical pickup actuator.

In the case of using the above DC motor moving the entire optical pickup actuator, although a low frequency tilt error of the optical disk might be corrected, however, a high frequency tilt error cannot be corrected. In addition, there exists a problem that a volume of the optical pickup actuator increases.

In another method of moving a blade with respect to the optical pickup actuator, moving coil type and moving magnetic type optical pickup actuators have been proposed. The moving coil type optical pickup actuator, however, is required a complicated assembling process since at least six wires are coupled to a driver to control a tilt correcting operation. Moreover, in the moving magnet type optical pickup actuator, it is very difficult to provide both the blade and the objective lens with a sufficient strength to perform a tilt correction operation.

In an effort to avoid the above problems, a hybrid type optical pickup actuator is proposed. However, the hybrid type optical pickup actuator lacks a desired sensitivity required in a high speed error correcting operation.

The moving coil type, the moving magnet type, and the hybrid type optical pickup actuators, as shown in FIGS. 1 through 3, are explained hereinafter.

FIG. 1 is a perspective view of a moving magnet type optical pickup actuator disclosed in Japanese Patent Publication No. 10-261233. A plurality of magnets are installed on a blade 2 mounted with an objective lens 1, through which a laser beam is transmitted on an optical disk D, and coils 5 are wound around corresponding yokes 4-1 formed on a yoke plate 4 mounted on a low portion of the blade 2 to correspond to the magnets 3. The number of windings of each coil 5 needs to be increased to improve a sensitivity of the optical pickup actuator. The increase of the number of the windings of the coils 5 causes a phase delay in driving the optical pickup actuator.

FIG. 2 is a perspective view of a moving coil type optical pickup actuator performing a twiaxial driving operation. Focusing coils 6 are mounted on the blade 2 having the objective lens 1, and tracking coils 7 are mounted on sides of the blade 2 lengthwise. A plurality of tracking magnets 3 are mounted on corresponding yokes 4-1 formed on the yoke plate 4, and a plurality of focusing magnets 5 are mounted on respective yokes 4-2 corresponding to the focusing coils 5.

In the above moving coil type optical pickup actuator, the blade 2 moves up and down in response to a first direction of electromagnetic force generated in the focusing coils 6 being spaced-apart from the focusing magnets disposed on the the yokes 4-2 and be moved in left and right directions by a second direction of electromagnetic force generated in the tracking coils 7 facing the tracking magnets 3 mounted on the corresponding yokes 4-1.

Although this moving coil type optical pickup actuator performing the twiaxial driving operation may use data obtained from a conventional design of the optical pickup actuator, a process of precisely asembling components becomes complicated, and an efficiency of the assembling process deteriorates.

FIG. 3 is a perspective view of a hybrid type optical pickup actuator, and FIG.4 is a plan view of an asymmetrical hybrid type optical pickup actuator. Generally, focusing coils 2-1 and tracking coils 2-2 is mounted on the blade 2, and tilt magnets 3-1 are mounted on opposite lengthwise sides of the blade 2. Inside and outside yokes 4-1 is mounted with the magnets 3 at widthwise sides thereof to drive the focusing coils 2-1 and the tracking coils 2-2. Tilting magnets 3-1 is also mounted on the lengthwise sides of the blade 2, and the tilting coils 9 are installed on the tilting yokes 4-2 to be disposed to correspond to respective tilting magnets 3-1 to control the blade 2 to be tilted when the electromagnetic force is generated between the tilting magnets 3-1 and the tilting coils 9.

This optical pickup actuator includes a structure to control the blade 2 to be tilted with respect to the objective lens 1 in response to the electromagnetic force generated from the tilting magnets 3-1 and the corresponding tilting coils 9.

Accordingly, this optical pickup actuator is required to perform a triaxial driving operation of controlling the laser beam to be precisely landed and reflected from the optical disk through the objective lens 1. The triaxial driving operation includes performing a tilting operation of controlling the blade 2 to be tilted in response to the electromagnetic force generated between the tilting coils 9 mounted on the yoke plate 4 and the tilting magnets 3-1 mounted on the opposite lengthwise sides of the blade 2.

However, in the asymmetrical hybrid type optical pickup actuator, as shown in FIG.4, there exists a problem in assembling the tilting magnets 3-1 and the tilting coils 9 due to the electromagnetic force between the tilting magnets 3-1 and tilting coils 9. If the number of the windings of the tilting coils 9 increases, there are disadvantages due to a time delay. If the number of the tilting coils 9 decreases to reduce a gap dy between the tilting coils 9 and the corresponding tilting magnets 3-1, the blade 2 lacks a space for a tracking operation although a driving force increases between the tilting coils 9 and the tilting magnets 3-1.

In a state that a gap dy between the tilting coils 9 and the corresponding tilting magnets 3-1 increases, if the blade 2 is moved in the tracking operation, a magnetic flux density in each side of the blade 2 varies, and at this time, problems occur due to a suction (attractive) force generated between a magnet and a yoke in a tracking direction in the tracking operation.

In the hybrid type optical pickup actuator, if a support (yoke) supporting the tilting coil is a magnetic material, such as a metal used for the yoke plate, the problems occur in assembling the magnet and the coil due to the suction force generated from the magnet. If the support made of a non-magnetic material is formed on the yoke plate in order to avoid the above problems, it is difficult to precisely mount the the support on the yoke plate and adjust a position of the magnet with respect to the tilting coil. In addition, it is very difficult to obtain a sensitivity required in the tilting operation. In this situation, if the number of the winding of the tilting coil increases, a phase delay occurs in the triaxial operation. This problems cause bad effects on an efficiency and a performance of the optical pickup actuator when the phase delay is generated, and when the magnetic flux density relating to the tilting operation varies in response to the tracking operation.

### SUMMARY OF THE INVENTION

In order to overcome these and other problems, it is an object according to the present invention to provide a triaxial driving optical pickup actuator having a tilting magnet and a tilting coil disposed in corresponding positions, in which a blade moving in tracking and focusing directions does neither effect on nor interfere with the tilting magnet and the tilting coil, and performing a triaxial driving operation, such as a focusing operation, a tracking operation, and the tilting operation.

Additional objects and advantages of the present invention will be set forth in part in the description which follows and, in part, will be obvious from the description, or may be learned by practice.

These and other objects may be achieved by providing an optical pickup actuator performing a triaxial driving operation according to an embodiment of the present invention. The optical pickup actuator includes an objective lens through which a laser beam is focused on an optical disk, a blade mounted with tracking coils and focusing coils at corresponding front or side portions thereof and with a plurality of tilting magnets at a rear side portion thereof, a yoke plate having inside and outside yokes mounted with tracking and focusing magnets 21 and also having a tilting yoke 23 formed at a position being spaced-apart from the inside and outside yokes 22 in a direction of forming the inside and outside yokes, a plurality of suspension wires disposed on longitudinal opposite sides of the blade to be electrically coupled to the tracking coils and focusing coils of the blade, a wire holder having a plurality of coupling elements through which each portion of the suspension wires passes, a yoke receptacle disposed between the coupling elements at a front portion of the yoke plate to receive the tilting yoke, and a printed circuit board (PCB) mounted on a rear side of the holder to be electrically coupled to the suspension wires, and a tilting coil disposed around the tilting yoke and around a circumference of the yoke receptacle to generate an electromagnetic force to the tilting magnet.

The optical pickup actuator according to another embodiment of the present invention includes the objective lens through which the laser beam is focused on the optical disk, the blade mounted with tracking coils and focusing coils at corresponding front and side portions thereof and with a plurality of tilting magnets at a rear side portion thereof, a yoke plate having inside and outside yokes mounted with tracking and focusing magnets and also having a plurality of tilting yokes formed at a position being spaced-apart from the inside and outside yokes in the direction of forming the inside and outside yokes, a plurality of suspension wires disposed on longitudinal opposite sides of the blade to be electrically coupled to the tracking coils and focusing coils, a wire holder having a plurality of coupling elements through which corresponding suspension wires pass, a plurality of yoke receptacles disposed between the coupling elements at a front portion of the yoke plate to receive corresponding tilting yokes and a printed circuit board (PCB) mounted on a rear side of the holder to be electrically coupled to the suspension wires, and a plurality of tilting coils disposed respective outer sides of the yoke receptacles to generate the electromagnetic forces with respective to the corresponding tilting magnets.

### BRIEF DESCRIPTION OF THE DRAWINGS

These and other objects and advantages of the present invention will become apparent and more readily appreciated from the following description of the preferred embodiments, taken in conjunction with the accompanying drawings of which:

FIG. 1 is a perspective view of a conventional moving magnet type optical driving actuator;

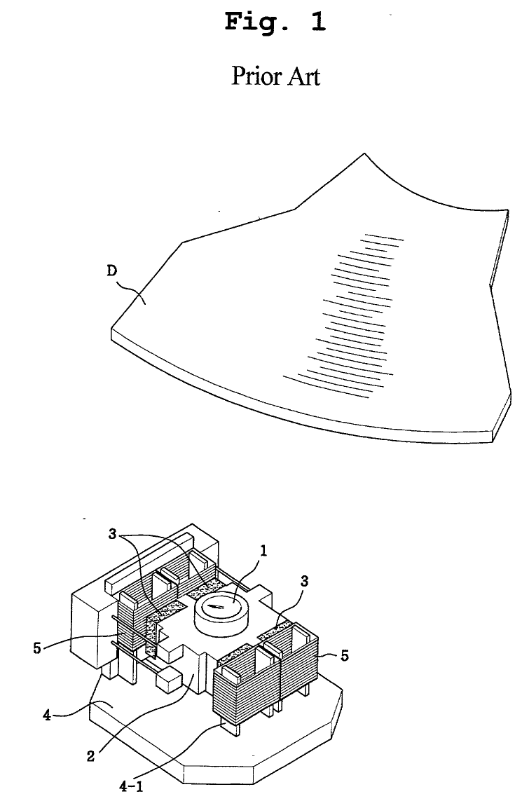

FIG. 2 is a perspective view of a conventional moving coil type optical pickup actuator;

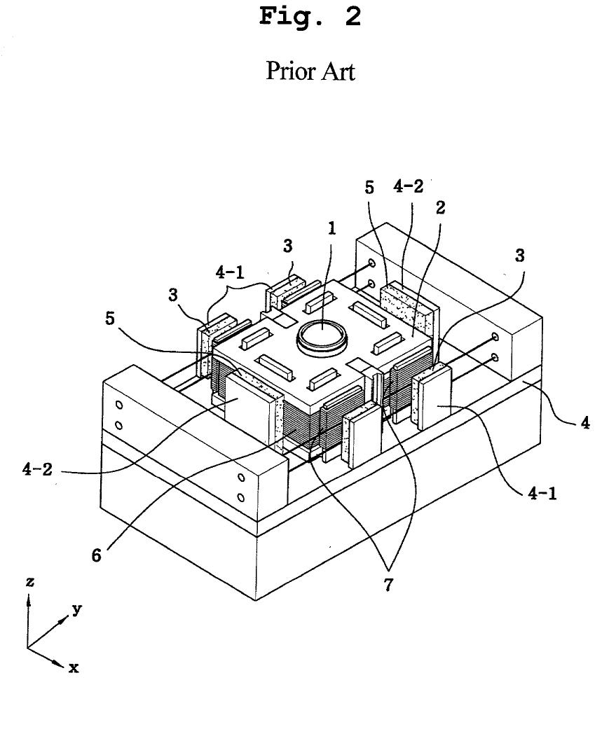

FIG. 3 is a perspective view of a conventional hybrid type optical pickup actuator;

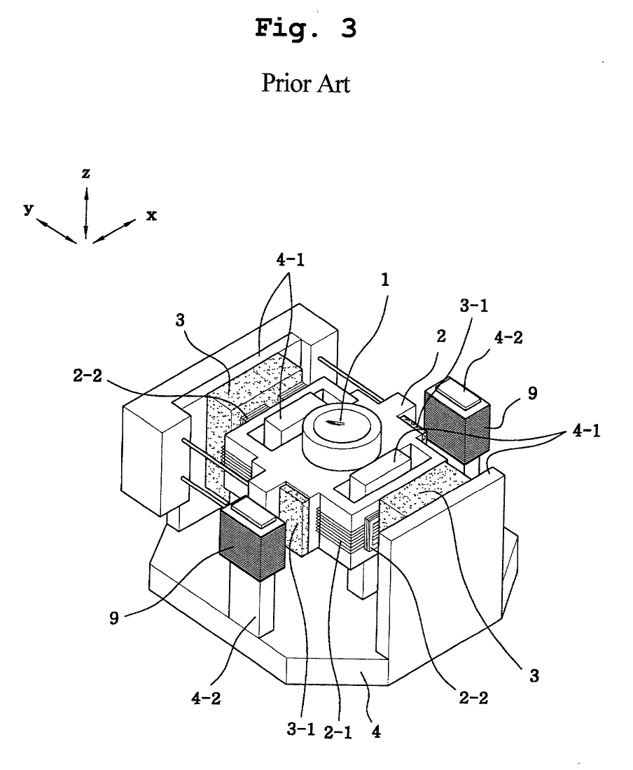

FIG. 4 is a plan view of a conventional asymmetrical hybrid type of the optical pickup actuator of FIG. 3;

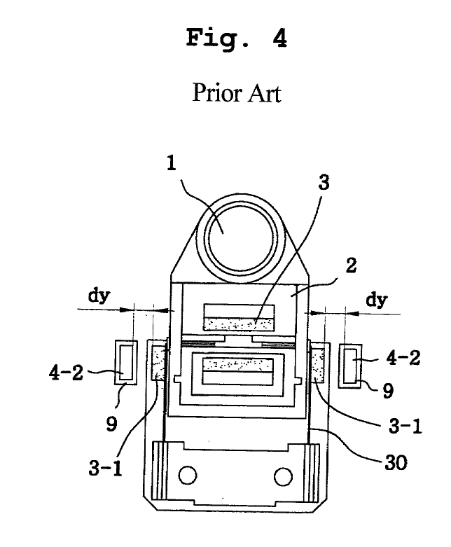

FIG. 5 is a perspective view of a triaxial driving type optical pickup actuator according to an embodiment of the present invention;

FIG. 6 is an exploded view of the triaxial driving type optical pickup actuator of FIG. 5;

FIG. 7 is a plan view of the triaxial driving type optical pickup actuator of FIG. 5;

FIG. 8 is a partial perspective view showing a tilting operation in response to a current generated in a tilting coil with respect to a tilting magnet of the triaxial driving type optical pickup actuator of FIG. 5;

FIG. 9 is a perspective view of a second triaxial driving type optical pickup actuator according to another embodiment of the present invention; and

FIG. 10 is a partial perspective view showing a tilting operation by a current generated between a tilting magnet and a plurality of tilting coils of the triaxial driving type optical pickup actuator of FIG. 9.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

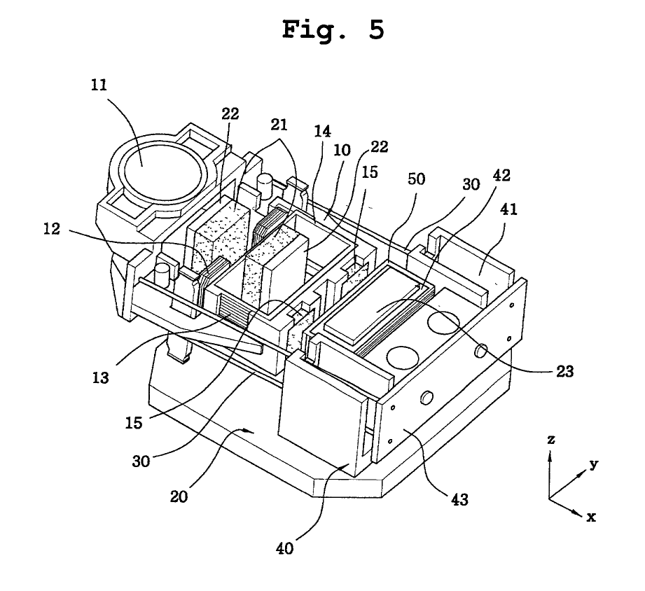

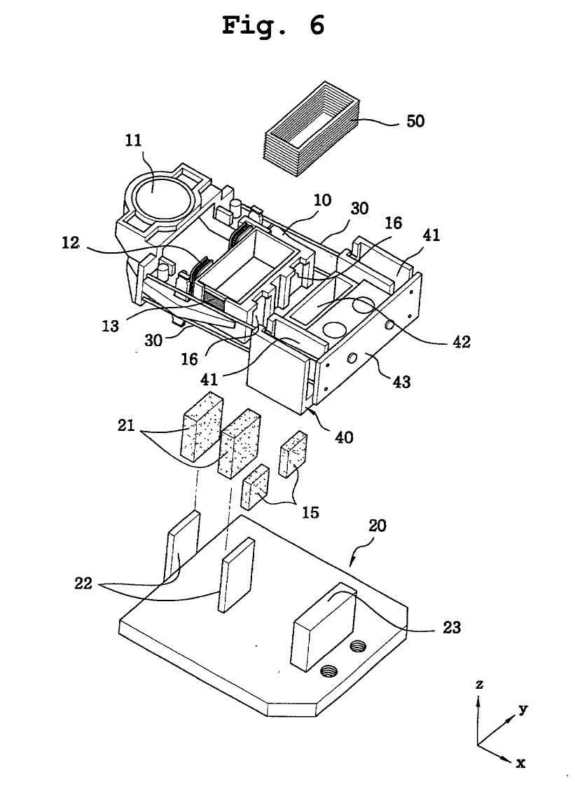

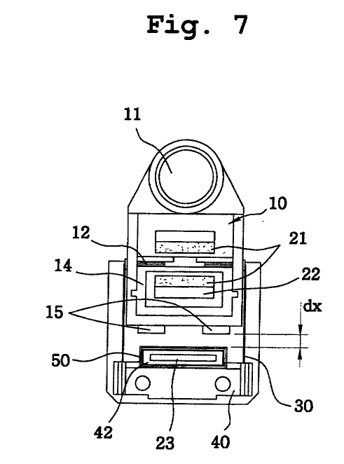

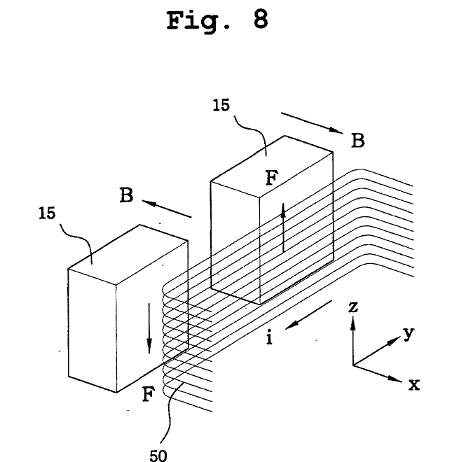

Referring now to FIGS. 5 through 10, FIG. 5 is a perspective view of an optical pickup actuator performing a triaxial driving operation according to an embodiment of the present invention, FIG. 6 is an exploded view of the optical pickup actuator of FIG. 5, FIG. 7 is a plan view showing a tilting operation during a tracking operation performed by the optical pickup actuator, and FIG. 8 is a partial perspective view explaining the tilting operation and a current generated between the tilting magnet and the tilting coil according to the optical pickup actuator of FIG. 5.

The optical pickup actuator performing the triaxial driving operation according includes an objective lens 11 through which a laser beam is focused on an optical disk, a blade 10 mounted with tracking coils 12 and focusing coils 13 at corresponding front and side portions thereof and with a plurality of tilting magnets 15 at a rear side portion thereof, a yoke plate 20 having inside and outside yokes 22 mounted with tracking and focusing magnets 21 and also having a tilting yoke 23 formed at a position being spaced-apart from the inside and outside yokes 22 in a direction of forming the inside and outside yokes 22 on the blade 10, a plurality of suspension wires 30 disposed on longitudinal opposite sides of the blade 20 to be electrically coupled to the tracking coils 12 and focusing coils 12, a wire holder 40 having a plurality of coupling elements 41 through which each portion of the suspension wires 30 passes, a yoke receptacle 42 disposed between the coupling elements 41 at a front portion of the yoke plate 20 to receive the tilting yoke 23, and a printed circuit board (PCB) 43 mounted on a rear side of the wire holder 40 to be electrically coupled to the suspension wires 30, and a tilting coil 50 disposed around the tilting yoke 23 and around a circumference of the yoke receptacle 42 to generate an electromagnetic force to the tilting magnet 15.

The blade 10 includes the objective lens 11, the tracking and focusing coils 12, 13, and the tilting magnets 15 in a lengthwise direction parallel to a center line of the blade 10. The tracking and focusing coils 12, 13 are disposed between said objective lens 11 and said tilting magnets 15. The blade 10 includes openings in the lengthwise direction. The yoke plate 20 includes tracking and focusing magnets 22 and the tilting yoke 23 in the lengthwise direction. The tracking and focusing magnets 22 protrude through corresponding openings of the blade 10 to be disposed adjacent to the corresponding tracking and focusing coils 12, 13, and the tilting yoke 23 is disposed adjacent to the tilting magnets 15. The wire holder 40 is disposed adjacent to the tilting magnets 15 of the blade 10 opposite to the objective lens 11. The suspension wires 30 are disposed on the longitudinal opposite sides of the blade 10 in the lengthwise direction to electrically couple the tracking and focusing coils 12, 13 to the wire holder 40. The tilting coil 50 is disposed around the tilting yoke 23 to face the tilting magnets 15 of the blade 10.

The plurality of the tilting magnets 15 having opposite polarities are disposed on a portion of the blade 10 corresponding to the tilting coil 50. The tilting magnets may be made of a single magnet having the opposite polarities at each end portion thereof.

Insertion holes 16 are formed on both opposite sides of a wall of the blade 10 with respect to the center line of the blade 10 to accommodate corresponding tilting magnets 15. The insertion holes 16 have the same shape as the tilting magnets 15 inserting into the insertion hoes 16 and are disposed on opposite sides with respect to the center line passing the objective lens 11 mounted on the blade 10.

If the blade 10 is not provided with the insertion holes 16, the tilting magnets 15 might be disposed on a surface of the wall of the blade 10 at the opposite sides of the blade 10 with respect to the center line of the blade 10. The wall surface is perpendicular to the center line of the blade 10.

The insertion holes 16 and the tilting magnets 15 inserted into the corresponding insertion holes 15 may be disposed on one of the front and rear sides of the blade 10 or both front and rear sides of the blade 10. If the insertion holes 16 and the tilting magnets 15 are disposed on the front a rear sides of the blade 10, a plurality of the tilting yoke 23 are disposed to correspond to each of the tilting magnets 15, and a plurality of the tilting magnets 15 is disposed to correspond to the tilting coil 50 to perform the tilting operation of the optical pickup actuator.

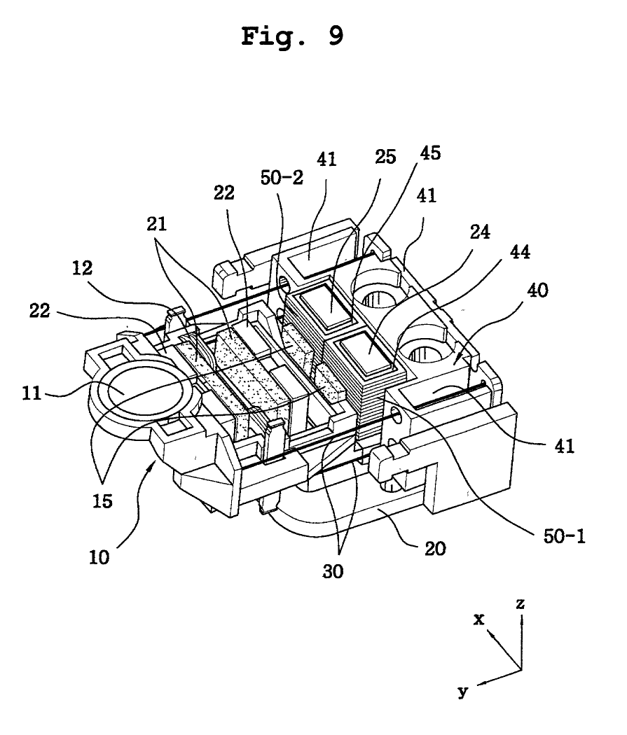

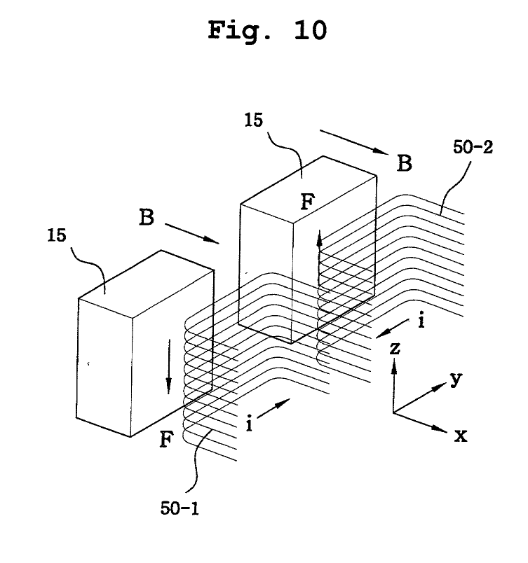

FIG. 9 is a perspective view showing a second optical pickup actuator performing the triaxial driving operation according to another embodiment of the present invention, and FIG. 10 is a partial view showing a tilting operation and a current generated in the tilting coil with respect to the tilting magnets of FIG. 9. The optical pickup actuator includes the objective lens 11 through which the laser beam is focused on the optical disk, the blade 10 mounted with tracking coils 12 and focusing coils 13 at corresponding front and side portions thereof and with a plurality of tilting magnets 15 at a rear side portion thereof, a yoke plate 20 having inside and outside yokes 22 mounted with tracking and focusing magnets 21 and also having a plurality of tilting yokes 24, 25 formed at a position being spaced-apart from the inside and outside yokes 22 in a direction of forming the inside and outside yokes 22 on the blade 10, a plurality of suspension wires 30 disposed on the longitudinal opposite sides of the blade 20 to be electrically coupled to the tracking coils 12 and focusing coils 12, a wire holder 40 having a plurality of coupling elements 41 through which each portion of the suspension wires 30 passes, a plurality of yoke receptacles 42 disposed between the coupling elements 41 at a front portion of the yoke plate 20 to receive corresponding tilting yokes 24, 25, and a printed circuit board (PCB) 43 mounted on a rear side of the holder 40 to be electrically coupled to the suspension wires 30, and a plurality of tilting coils 50-1, 50-2 disposed around respective circumferences of the yoke receptacles 42 and around corresponding tilting yoke 24, 25 to generate the electromagnetic forces with respective to the corresponding tilting magnets 15.

The tilting magnets 15 are disposed on longitudinal opposite sides of a rear portion of the blade 10 respect to the center line of the blade 10 to correspond to the respective tilting coils 50-1, 50-2 which have the same magnetic polarity as the corresponding tilting magnets 15.

The blade 10 is classified into two types according to the optical pickup actuator. A first type blade includes an objective lens 11 mounted on a front side thereof and a tilting magnet and a tilting coil mounted on a rear side opposite to the front side thereof and is mounted in an optical pickup actuator adapted for use in slim type compact disk (CD) player. A second type blade includes a tilting magnet and a tilting coil mounted on a side in the lengthwise direction along suspension wires and is mounted in the optical pickup actuator adapted for use in a general type CD or DVD disk player.

A process and an effect of the optical pickup actuator performing the triaxial driving operation are explained hereinafter.

The electromagnetic force applied to the focusing coil 13 and the tracking coil 12 of the blade 10 and the focusing and tracking magnets 22 mounted on the yoke 22 of the yoke plate 20 enables the blade 10 of the optical pickup actuator to perform the focusing operation of focusing the laser beam on the optical disk and the tracking operation of precisely landing the laser beam on a tracking position of a data storing surface of the optical disk to read data from and write the data on the optical disk.

In the tilting operation of the optical pickup actuator preventing a tilting aberration generated when the optical disk rotates in a high speed, the electromagnetic force applied to the tilting magnets 15 disposed in the corresponding insertion holes 16 of the blade 10 and the tilting coil 50 mounted on the tilting yoke 23 of the yoke plate 20 enables the blade 10 of the optical pickup actuator to perform the tilting operation.

As sown in FIG. 8, the plurality of tilting magnets 15 each having one of N and S magnetic polarities are disposed on opposite portions of the blade 10 with respect to the center line of the blade 10 passing through the objective lens 11, and the tilting coil 50 is disposed spaced-apart from the tilting magnets 15 to generate the electromagnetic force for the tilting operation. A reference characters “B”, “i”, and “F” denote a direction of the electromagnetic force, a direction of the current applied to the tilting coil 50, and a Lorents force generated from a reaction between the direction “B” of the electromagnetic force and the direction of the current “i”, respectively.

Although the current flows in a predetermined direction, a pair force is applied to the blade 10 since the opposite polarities of the tilting magnets 15 are disposed on opposite portions of the blade 10. Since this pair force is a moment in a direction of an X axis, the blade 10 moves about the X axis to perform the tilting operation.

The tilting operation is performed without interference with the focusing and tracking operation because the tilting magnet 15 and the tilting coil 50 are spaced-apart from the focusing coil 13 and the tracking coil 12 as shown in FIG. 7.

A magnetic flux between the tilting magnet 15 and the tilting coil 50 is not changed during the tilting operation since a gap dx between the tilting magnet 15 and the tilting coil 50 is maintained constant during the tracking operation. This tilting and tracking operations according to the embodiment of the present invention do not cause any variance of the magnetic flux which occured with the conventional optical pickup actuator performing the tracking operation and the tilting operation.

Since the optical pickup actuator performs the tilting operation within a minimum range of the gap dx, in which the tracking and the focusing operations are not interfered, formed between the tilting magnet 15 and the tilting coil 50, it is an advantage of this optical pickup actuator to have a driving constant of a driving force greater than that of the conventional hybrid type optical pickup actuator.

Because the aberration of the laser beam with respect to the optical disk is reduced, a production efficiency is improved. Moreover, a problem causing a pit to be deformed during writing of information data on the optical disk is removed, and recorded signals on the optical disk does not deteriorate.

The optical pickup actuator can perform the triaxial driving operation, such as the focusing operation, the tracking operation, and the tilting operation because the optical pickup actuator includes the tilting coil 50 independently mounted at a front portion of the coupling element 41 through the yoke receptacle 42 of the wire holder 40, and because a plurality of the tilting magnets 15 are mounted on both sides of the blade 10 at corresponding positions of the tilting coil 50.

An arrangement of the yoke receptacle 42 of the wire holder 40, the tilting magnet 15, and the tilting coil 50 improve an efficiency of an assembling process and might use the same design data and assembling process as that of the conventional optical pickup actuator. For example, a simple assembling process and a simple wiring process which are used in another twiaxial driving type optical pickup actuator may be used in this optical pickup actuator.

As shown in FIG. 9, the optical pickup actuator performs the tilting operation using a tilting driving unit having the tilting coils 50-1, 50-2 disposed in yoke receptacles 44, 45 formed on the yoke plate 20, and two tilting magnets 15 having the same polarities as the corresponding tilting coils 50-1, 50-2 are mounted on the rear side of the blade 10 at corresponding positions facing the corresponding tilting coils 50-1, 50-2.

The tilting operation of the optical pickup actuator of FIG. 9 is described hereinafter. If the current flow of one of the tilting coil 50-1, 50-2 disposed in on the tilting yoke 24, 25 is reversed, the tilting magnets 15 enable the blade 10 to perform a tilting movement in response to the current flow induced from the tilting coil 50-1, 50-2 although the tilting magnets 15 are disposed on the corresponding tilting coils 50-1, 50-2 having the same magnetic polarity. When the tilting operation is performed in response to the electromagnetic force generated between the tilting magnets 15 and the tilting coils 50-1, 50-2, the gap formed between the tilting magnets 15 and the tilting coils 50-1, 50-2 is not changed during the tilting operation even if the tracking and the focusing operation are simultaneously performed. Moreover, the driving constant of the driving force of the optical pickup actuator becomes greater to improve the tilting operation.

As described above, the optical pickup actuator according to the present invention includes a tilting coil mounted on a wire holder and a tilting magnet mounted on a blade to perform both the tracking and focusing operation and the tilting operation without any interference with each other and to improve the driving constant of the driving force because the gap between the tilting magnet and the tilting coil is maintained constant. The aberration of the laser beam generated from the twisted or bent optical disk is reduced, and the reading and writing efficiency of the optical pickup actuator is improved.

Although a few preferred embodiments of the present invention have been shown and described, it would be appreciated by those skilled in the art that changes may be made in third embodiment without departing from the principles and sprit of the invention, the scope of which is defined in the claims and their equivalents.

What is claimed is:

1. An optical pickup actuator performing a triaxial driving operation, comprising:
a blade having an objective lens through which a laser beam is focused on an optical disk, tracking coils and focusing coils at corresponding portions thereof, a plurality of tilting magnets at a rear side portion thereof;
a yoke plate having tracking and focusing yokes, tracking and focusing magnets mounted on corresponding tracking and focusing yokes, and a tilting yoke formed in a direction of forming said yokes;
a plurality of suspension wires disposed on both sides of said blade to be electrically coupled to said tracking coils and said focusing coils;
a wire holder having a plurality of coupling elements through which each portion of said suspension wires passes, a yoke receptacle disposed between said coupling elements at a portion of said yoke plate to receive said tilting yoke, and a printed circuit board mounted on a rear side of said holder to be electrically coupled to said suspension wires; and
a tilting coil disposed in said yoke receptacle and wound around said tilting yoke to generate an electromagnetic force to said tilting magnet.

2. The actuator of claim 1, wherein said tilting magnets have one of opposite polarities to correspond to said tilting coil.

3. The actuator of claim 1, wherein said blade has a symmetric shape with respect to a centerline disposed lengthwise between said suspension wire.

4. An optical pickup actuator performing a triaxial driving operation, comprising:
a blade having an objective lens through which a laser beam is focused on an optical disk, tracking coils and focusing coils at corresponding portions thereof, a plurality of tilting magnets at a rear side portion thereof;
a yoke plate having inside and outside yokes mounted with tracking and focusing magnets and having a tilting yoke in a direction of forming said inside and outside yokes on said blade;
a plurality of suspension wires disposed on both sides of said blade to be electrically coupled to said tracking coils and said focusing coils;
a wire holder having a plurality of coupling elements through which each portion of said suspension wires passes, a plurality of yoke receptacles disposed between said coupling elements at a front portion of said yoke plate to receive said tilting yoke, and a printed circuit board mounted on a rear side of said holder to be electrically coupled to said suspension wires; and
a plurality of tilting coils disposed in corresponding yoke receptacles to generate an electromagnetic force to said tilting magnet.

5. The actuator of claim 4, wherein said tilting magnets and said tilting coils facing corresponding tilting magnets have the same polarity.

6. The actuator of claim 4, wherein said blade is a symmetric shape with respect to a center line disposed between said suspension wires in lengthwise and has said objective lens mounted a side thereof, the center line passing through a center of said objective lens.

7. An optical pickup actuator performing a triaxial driving operation, comprising:
a wire holder;
a blade having a plurality of parallel suspension wires extended from said wire holder and disposed on opposite sides with respect to a lengthwise center line of said blade to connect said blade to said wire holder in a lengthwise direction;
a plurality of tilting magnets disposed on said blade and between said suspension wires; and
a tilting coil disposed on said wire holder to face said tilting magnets.

8. The actuator of claim 7, wherein said tilting magnets have one of opposite polarities with respect to said tilting coil.

9. The actuator of claim 7, wherein said actuator comprises an additional tilting coil disposed on said wire holder, and said tilting coil and said additional tiling coil disposed to face corresponding tilting magnets.

10. The actuator of claim 9, wherein one of said tilting magnet and said tilting coil corresponding to said one of said tilting magnet have the same polarity, and another one of said tilting magnet and said additional tilting coil corresponding to said another one of said tilting magnets have the same polarity.

11. An optical pickup actuator performing a triaxial driving operation, comprising:
a blade having an objective lens, a plurality of tilting magnets, and tracking and focusing coils disposed between said objective lens and said tilting magnets, and having openings formed in a lengthwise direction parallel to a center line of the blade;
a yoke plate having tracking and focusing magnets and a tilting yoke in said lengthwise direction, said tracking and focusing magnets protruding through corresponding openings of said blade to be disposed adjacent to correswponding tracking and focusing coils, said a tilting yoke disposed adjacent to said tilting magnets;
a wire holder disposed adjacent to said tilting magnets of said blade opposite to said objective lens;
a plurality of suspension wires disposed on both sides of said blade in said lengthwise direction to electrically couple said tracking coils and said focusing coils to said wire holder; and
a tilting coil disposed around said tilting yoke to face said tilting magnet of said blade.

12. The actuator of claim 11, wherein said tilting magnets are spaced-apart from said tracking and focusing coils in said lengthwise direction.

13. The actuator of claim 11, wherein said tilting magnets and said tilting coil is spaced-apart from said tracking and focusing coil in said lengthwise direction.

14. The actuator of claim 11, wherein said objective lens, said tracking and focusing lens, said tilting magnets, and said tilting coil are disposed in said lengthwise direction.

15. The actuator of claim 11, wherein said blade comprises insertion holes formed on opposite sides thereof with respect to a center line parallel to said lengthwise direction, and said insertion holes receiving corresponding tilting magnets.

16. The actuator of claim 11, wherein said tilting magnets are disposed on opposite sides of said blade with respect to a center line parallel to said lengthwise direction.

17. The actuator of claim 11, wherein said tilting magnets are disposed between said tilting yoke and said tracking and focusing coils.

18. The actuator of claim 11, wherein said tilting magnets are disposed opposite ends of said tilting coils with respect to a center line parallel to said lengthwise direction.

19. The actuator of claim 11, wherein said tilting magnets and said tilting coil forms a gap in said lengthwise direction.

20. The actuator of claim 11, wherein said tilting magnets and said tilting coil are separated in said lengthwise direction by a predetermined constant distance when said blade moves by said tracking and focusing coils..

21. The actuator of claim 11, wherein said tilting magnets and said tilting coil generates a constant magnetic flux when said blade moves by said tracking and focusing coils.

22. The actuator of claim 11, wherein said wire holder comprises a printed circuit board coupled to said parallel suspension wires and said tilting coil.

23. The actuator of claim 11, wherein said wire holder comprises a printed circuit board coupled to said parallel suspension wires and said tilting coil, and said printed circuit board, said tilting coil, said tilting magnets, and said tracking and focusing coils are arranged in said lengthwise direction.

24. The actuator of claim 11, wherein said tilting coil of said wire holder, said tilting magnets and said tracking and focusing coils of said blade, and said tracking and focusing magnets of said yoke plate are disposed between said suspension wires.

25. The actuator of claim 11, wherein said wire holder comprises coupling elements disposed opposite ends with respect to a center line parallel to said lengthwise direction, and each portion of said suspension sire passes through respective coupling elements.

26. The actuator of claim 11, wherein said wire holder comprises coupling elements disposed opposite sides of said tilting yoke of said yoke plate, and each portion of said suspension sire passes through respective coupling elements.

27. The actuator of claim 11, wherein said tracking and focusing coils and said tilting magnets of said blade moves with respect to said wire holder and said yoke plate.

28. An optical pickup actuator performing a triaxial driving operation, comprising:
a blade having an objective lens, tracking and focusing coils, and a tilting magnet arranged in a lengthwise direction parallel to a center line of said blade;
a yoke plate having tracking and focusing magnets and a tilting yoke disposed in said lengthwise direction and adjacent to said tracking and focusing coils and adjacent to said tilting magnets, respectively;
a wire holder disposed adjacent to said tilting magnets of said blade opposite to said objective lens;
a plurality of suspension wires disposed on opposite sides of said center line of said blade to be coupled between said blade and said wire holder and to electrically couple said tracking coils and said focusing coils to said wire holder; and
a tilting coil disposed around said tilting yoke to face said tilting magnet of said blade.
